(19) United States
(12) Patent Application Publication
(10) Pub. No.: US 2025/0341125 A1
(43) Pub. Date: Nov. 6, 2025

(54) DISPLACEMENT DEVICE WITH A MOUNTING PROFILE, INSTALLATION METHOD AND FUNCTIONAL ENTITY

(71) Applicant: HAWA SLIDING SOLUTIONS AG, Mettmenstetten (CH)

(72) Inventor: Pascal PREHM, Untersiggenthal (CH)

(73) Assignee: HAWA SLIDING SOLUTIONS AG, Mettmenstetten (CH)

(21) Appl. No.: 18/869,356

(22) PCT Filed: May 12, 2023
(86) PCT No.: PCT/EP2023/062855

§ 371 Date: Nov. 26, 2024

(30) Foreign Application Priority Data
Jun. 1, 2022 (EP) 22176723.9

(51) Int. Cl. E05F 1/16; E05D 13/00; E05D 15/26

(52) U.S. Cl. CPC E05F 1/16; E05D 13/00; E05D 15/264

(57) ABSTRACT

A displacement device includes a mounting profile vertically aligned by a holding device displaceable between first and second end positions of a driveway and connected or connectable by mounting hinges to a single-part or multi-part door. The holding device includes first and second front-and rear-sided cable connection devices, connected to each other by holding cables. The second rear-sided cable connection device includes a tensioning device with a pull spring, connected directly or via a connection sledge to the holding cable and is connected to a pull sledge, into which a tensioning screw is screwed, by means of which the pull sledge can be displaced within a bearing profile along its longitudinal axis in order to tension the pull spring. The first front- or rear-sided cable connection device includes a setting device with a setting sledge, connected to the fixed holding cable and cooperates with a fixedly held setting screw.

The invention relates to a displacement device with a mounting profile which is connected to a single-part or multi-part door, possibly a foldable sliding door, and is vertically aligned and preferably automatically displaceable within a door compartment, a functional entity, in particular a piece of furniture or a room unit, with at least one displacement device, and a method for installing the displacement device within the functional entity.

For closing off openings of functional entities, such as pieces of furniture, room units, kitchens or sleeping areas, single-part or multi-part doors are often used, possibly foldable sliding doors, which are moved into a door compartment of the functional entity after the opening has been opened so that they do not interfere with the appearance.

U.S. Pat. No. 8,336,972B2 discloses a piece of furniture with a displacement device by means of which a mounting profile connected to a single-part door is displaceable within a door compartment. The displacement device comprises a holding device in the form of a scissor cross, by means of which the mounting profile is held displaceably in vertical alignment. The displacement device further comprises running rails along which the mounting profile is displaceably mounted by means of running gears.

U.S. Pat. No. 9,284,761B2 discloses a piece of furniture with a displacement device by means of which a mounting profile connected to a foldable sliding door is displaceable within a door compartment. The foldable sliding door comprises two door elements, of which the first door element is connected at the rear by mounting hinges to the mounting profile and at the front by door hinges to the rear of the second door element, which is connected at the front to a front carriage which is displaceable along a running rail having two rail sections aligned perpendicularly to one another and connected to one another by a curved section, of which a first rail section extends into the door compartment and a second rail section extends along the front of the piece of furniture.

In the aforementioned sliding devices, the mounting profile with the sliding door is manually pushed into the door compartment and manually pulled out of the door compartment again. Sliding devices are also known in which a mounting profile connected to a sliding door can be automatically displaced within a door compartment by means of a drive device.

DE2045763A1 discloses a piece of furniture with a displacement device with a scissor cross, the scissor arms of which are connected to each other by a spring to automatically retract a mounting profile held by the scissor cross and connected to a door into a door compartment or to eject it from the door compartment. The scissor cross takes up a relatively large amount of space and is typically adapted to the dimensions of the specific door compartment.

U.S. Pat. No. 10,227,806B2 discloses another displacement device with a control curve by means of which a mounting profile connected to a door is automatically displaceable within a door compartment.

The last described displacement devices have a drive device for the automatic displacement of the mounting profile, which either cooperate with specially designed holding devices and need to be integrated into these holding devices, or which, as separate drive devices, grasp the mounting profile near an end stop and pull it into the end positions. The separate drive devices usually require a lot of space and are only able to move the mounting profile over a short distance. These drive devices are also relatively expensive and only available in predefined sizes.

The drive devices and the other elements of the displacement devices must therefore be adapted to each other and are thus subject to significant restrictions. It should be noted that within the door compartment, which is possibly designed to accommodate more than one door element, there is usually little space available. Hence, restrictions on the integration of the drive device into the displacement device are particularly critical.

EP1394349A1 discloses a displacement device with a slidably mounted mounting profile, which is held perpendicular to the direction of displacement by means of a holding device having two metal cables. The mounting profile is provided with two lower wheels at the lower end and two upper wheels at the upper end, which are provided for rolling on an upper and a lower guide rail. The first metal cable is guided clockwise around the associated upper wheel and counterclockwise around the associated lower wheel and is held and tensioned on both sides by means of cable connection devices arranged on the front side and rear side of the displacement device. The second metal cable is guided counterclockwise around the associated upper wheel and clockwise around the associated lower wheel and held and tensioned on both sides by means of cable connection devices arranged on the front and rear of the displacement device.

U.S. Pat. No. 4,976,502A discloses a further holding device with two metal cables by means of which a mounting profile is held displaceably in vertical alignment.

A disadvantage of these devices is that the function of the holding device depends largely on the adjustment of the cable tensions. If the cable tensions are not set correctly, the mounting profile may not be held correctly, or blockages may occur. It should also be noted that installations of the displacement device at the installation site are carried out by different installers. This will result in different settings, which will affect the function of the displacement device and will cause maintenance to be required.

In addition, when forces are applied, excessive loads can occur in sliding devices that are not optimally installed, which can cause damage and require readjustment.

Even with optimal adjustment of the displacement device, there is the problem that blockages can occur when forces are applied to the displacement device.

The present invention is therefore based on the object of providing an improved displacement device by means of which a mounting profile, which is connected or connectable to a single-part or multi-part door, is displaceable in a vertically aligned manner within a door compartment of a functional entity, a piece of furniture or a room unit. Furthermore, a method for installing the displacement device shall be defined. Furthermore, functional entity, a piece of furniture or a room unit, with at least one improved displacement device shall be provided, by means of which a mounting profile connected to a door, possibly a foldable sliding door, is advantageously displaceable within a door compartment of the functional entity.

The displacement device shall be compact and easy to assemble and take up only little space, so that a lot of space can be kept free within the door compartment of the functional entity and the door compartment can be realised with reduced dimensions.

The displacement device shall easily and precisely be adjustable, so that the displacement device is always optimally set, independent of the respective installer.

The displacement device shall function reliably even when subjected to undesirable forces and shall not be subjected to loads that could cause damage. The displacement device shall be robust and resilient. Maintenance work and readjustments shall be avoided as far as possible, even when operated under high stress and load.

Preferably, the mounting profile of the displacement device shall be automatically displaceable within the door compartment so that a mounted door is automatically retracted into the door compartment or automatically driven out of the door compartment.

This task is solved with a displacement device according to claim 1, a method for installing this displacement device according to claim 13 and an improved functional entity according to claim 16, which has at least one door compartment with a displacement device according to claim 1 arranged therein. Advantageous embodiments of the invention are defined in further claims.

The displacement device, which is provided for the installation in a door compartment of a functional entity, comprises a mounting profile, which is held vertically aligned by a holding device displaceable between a first end position and a second end position of a driveway and which is connected or connectable by mounting hinges to a single-part or multi-part door.

The holding device comprises
a first front-sided cable connection device, a first lower roller unit supported at a lower end of the mounting profile, a first upper roller unit supported at an upper end of the mounting profile, and a first rear-sided cable connection device, and a first holding cable connected by a first end piece to the first front-sided cable connection device, routed around the first lower roller unit and around the first upper roller unit, and connected by a second end piece to the first rear-sided cable connection device; and
a second front-sided cable connection device, a second upper roller unit supported at the upper end of the mounting profile, a second lower roller unit supported at the lower end of the mounting profile, and a second rear-sided cable connection device, and a second holding cable connected by a first end piece to the second front-sided cable connection device, routed around the second upper roller unit and around the second lower roller unit and connected by a second end piece to the second rear-sided cable connection device.

According to the invention
the second rear-sided cable connection device comprises a second tensioning device with a second pull spring, which on the one hand is connected directly or via a second connection sledge to the second holding cable and which on the other hand is connected to a second pull sledge, into which a second tensioning screw is screwed which is held rotatable in a fixed position and by means of which the second pull sledge can be displaced within a second bearing profile along its longitudinal axis in order to tension the second pull spring; and
the first rear-sided cable connection device or the first front-sided cable connection device comprises a first setting device with a first setting sledge, which on the one hand is connected to the fixed first holding cable and which on the other hand cooperates with a fixedly held setting screw, which is rotatably held in the first setting sledge.

The two holding cables of the holding device, for example cables made of steel, possibly coated with precious metal and/or plastic, always hold the mounting profile in perpendicular alignment to the guide rails during the displacement within the door compartment. The sliding device can also be realised with a kinematic inversion or mirroring of device parts.

According to the invention, one of the holding cables of the holding device is always held elastically, while the other holding cable, which is not held elastically, is used to adjust the mounting profile. The elastic holding of the second holding cable ensures that no blockages occur. Impacts can be elastically absorbed so that no excessive stresses occur on the displacement device. The inventive displacement device can therefore be operated for a longer period without requiring maintenance. The adjustment of the setting device, if installed at the front side, can be carried out directly at the entrance of the door compartment in a simple manner.

By operating the setting device, the portion of the first holding cable that is active in the holding device is lengthened or shortened, thereby adjusting the inclination of the mounting profile. This adjustment is facilitated by the elastic coupling of the second holding cable. The first holding cable prevents the mounting profile from tilting forward towards the exit of the door compartment under the effect of the weight of the mounted door.

The holding device functions optimally, if the tensile force in at least the elastically held holding cable is set to a predetermined value. Preferably, a predetermined tensile force is also set or impressed in the first holding cable. The tensile forces set in the holding cables are preferably identical.

The pulling force should not be too low, but also not too high, so that on the one hand instabilities and on the other hand blockages or overloads are avoided. By operating the second tensioning device, the pull sledge can be displaced in relation to the connection sledge, thereby stretching the pull spring and exerting a tensile force on the second pull cord. By checking the behaviour of the displacement device, optimal values for the tension or the mutual displacement of the connection sledge and of the pull sledge or the stretching of the pull spring can be determined. For the installation of the displacement device, an optimal mutual displacement of the pull sledge and of the connection sledge can therefore always be specified and set.

In a preferred embodiment, the first rear-sided cable connection device comprises a first tensioning device with a first connection sledge, which on the one hand is connected to the first holding cable and on the other hand is connected by a first pull spring to a first pull sledge, in which a first tensioning screw is held in an axially displaceable manner. By means of the first tensioning screw, the first pull sledge and the first connection sledge are displaceable with respect to each other within a first bearing profile along its longitudinal axis. Preferably, the first and second tensioning devices have identical parts.

In this preferred embodiment, the first and second holding cables can be tensioned with a predetermined tensile force. The first connection sledge is then fixed to the bearing housing, after which the vertical alignment of the mounting profile is achieved by operating the setting device as described above. The holding device therefore always works with an optimum setting and optimum tensile forces in the holding cables.

To set a desired pulling force in the holding cables in the pulling devices, a measuring rod is preferably connected to the pull sledge, which overlaps the connection sledge and indicates the mutual displacement of the pull sledge and of the connection sledge. Alternatively, the measuring rod is connected to the connection sledge, which overlaps the pull sledge and indicates the mutual displacement of the pull sledge and the connection sledge.

The measuring rod preferably comprises a control element, such as a control window or a pointer, by means of which the position is indicated on the connection sledge or on the pull sledge, which corresponds to the mutual displacement of the connection sledge and of the pull sledge and which can be read at the control element.

The connection sledge or pull sledge overlapped by the measuring rod has a corresponding grid or colouring which facilitates reading. Preferably, markings such as colours or a scale are provided. The tensioning screw is turned until the control element reaches the mark to be set according to the previously determined recommendation. For example, a table is provided in which the tensile forces to be set for different dimensions and weights of the held door are indicated. The bearing profile preferably has at least one elongated profile opening so that the mutual displacement of the connection sledge and the pull carriage within the bearing profile is visible.

The bearing profiles, at the entrance of which an entrance roller is preferably provided, are preferably aligned perpendicular to the guide rails. In this way, a relatively long bearing channel can be provided in the bearing profiles, which allows the connection sledge and the associated pull sledge to be adjusted over a long distance as required.

The installation of the displacement device described below can be carried out particularly easily if the first front-sided cable connection device or the first rear-sided cable connection device comprises a clamping device by means of which the associated first or second end piece of the first holding cable can be clamped and held, and/or if the second front-sided cable connection device or the second rear-sided cable connection device comprises a clamping device by means of which the associated first or second end piece of the second holding cable can be clamped and held. Due to these measures, it is not necessary that the holding cables are exactly dimensioned and provided with connection eyes, for example. Instead, the holding cables can be manually inserted, manually tensioned and clamped. Regardless of the dimensions of the displacement device, the holding cables can be installed advantageously. Afterwards, the holding cables can preferably be pre-tensioned to a predetermined tensile force by means of the tension springs. Preferably, the clamping devices are provided in the form of connection sledges in the rear-sided cable connection devices.

In a preferred embodiment, the mounting profile is connected at an upper end piece to an upper guide carriage, which has an upper carriage body and which is slidably mounted on an upper guide rail; and/or that the mounting profile is connected at a lower end piece to a lower guide carriage, which has a lower carriage body and which is slidably mounted on a lower guide rail. By using an upper guide carriage and/or a lower guide carriage, forces are absorbed that act vertically on the mounting profile. Therefore, only torques acting on the mounting profile need to be absorbed by the holding device.

Preferably, the first front-sided cable connection device is arranged at the front-sided end of the lower guide rail and held thereby, and/or the first rear-sided cable connection device is arranged at the rear-sided end of the upper guide rail and held thereby, and/or the second front-sided cable connection device is arranged at the front-sided end of the upper guide rail and held thereby, and/or the second rear-sided cable connection device is arranged at the rear-sided end of the lower guide rail. This results in a simple and stable assembly of the cable connection devices. Therefore, only the guide rails must be connected to a side wall of the functional entity, while practically all other parts of the displacement device, including front-sided stop devices, can be connected to the guide rails.

The optional drive device is also connected to the mounting profile or one of the guide carriages. The inventive displacement device can therefore be easily installed in any configuration in any door compartment.

The first lower roller unit and the second lower roller unit are preferably held coaxially aligned with each other by a lower bearing shaft connected to the lower carriage body of the lower guide carriages. The first upper roller unit and the second upper roller unit are preferably held coaxially aligned to each other by an upper bearing shaft, which is connected to the upper carriage body of the upper guide carriages. It is also possible to connect the bearing shafts to the mounting profile. However, the bearing shafts can be integrated into the guide carriage in a simpler way. This also results in a larger distance between the two bearing shafts. The roller units can rotate freely and independently of each other, so that the displacement of the mounting profile can take place without friction. This also ensures that the automatic displacement can take place efficiently by means of the at least one drive device.

The inventive displacement device preferably comprises at least one drive device having a housing in which a drive element and a transmission medium are provided by means of which a force can be transmitted from the drive element to the mounting profile.

For example, a so-called damping/pull-in device is used, by means of which the mounting profile or a part connected to it is gripped and pulled to an end stop.

In a preferred embodiment, a drive device is firmly connected with its housing to the mounting profile or to one of the guide carriages and can be moved together with the mounting profile. The transmission medium of this drive device is preferably a pull cord, which is led from the drive device directly or via a first deflection roller or via the first deflection roller and a second deflection roller to a pull cord connection, which is stationarily arranged at the first or second end position of the driveway or is connected to a part of the functional entity.

By means of the drive device the mounting profile can be moved automatically in one direction towards the first end position or in the other direction towards the second end position.

The drive device or the housing of the drive device is preferably arranged laterally next to the mounting profile or laterally next to one of the guide carriages in relation to the displacement axis of the mounting profile or in relation to the driveway of the mounting profile. This arrangement of the drive device avoids a shortening of the driveway. I.e., it is avoided that the housing of the drive device hits a stop before one of the guide carriages or the mounting profile hits a stop. The use of the drive device therefore does not cause any restriction of the displaceability of the mounting profile.

It is particularly advantageous that the drive device is slidably connected to the mounting profile or a guide carriage and does not have to be mounted on a part of the functional entity inside the door compartment that is hardly and possibly only accessible after removing a rear wall or side wall of the functional entity. Maintenance of the displacement device is also facilitated. For example, if the drive device needs to be serviced, only the mounting profile can be pulled towards the front of the door compartment to easily access the drive device.

The drive device can also be fully or partially integrated into the associated guide carriage, so that an even more compact structure of the displacement device can be realised.

In preferred embodiments, it is provided that the drive element is a spring element, a drive spring, such as a helical spring or a spiral spring, and that the pull cord is wound on a pull cord drum, which is rotatably mounted and connected to the drive element, whereby the drive element can be tensioned by rotation of the pull cord drum in one direction and the drive element can be released by rotation of the pull cord drum in the other direction.

If a first deflection roller is provided, it is preferably connected directly or indirectly to the mounting profile or to one of the guide carriages. A second deflection roller, if provided, is also preferably connected directly or indirectly to the mounting profile or to one of the guide carriages. In this way, the pull cord can be guided as needed and the displacement device can still be built compactly. The pull cord is guided and deflected close to the mounting profile, so no additional space is needed.

Preferably, the first deflection roller is displaceably mounted in relation to the housing of the drive device and in relation to the second deflection roller, whereby a pre-tension can be transmitted to the drive element. The pull cord is preferably guided from the housing of the drive device to the first deflection roller and preferably at least approximately parallel back to the second deflection roller.

The first deflection roller is preferably rotatably held by a deflection unit, which is form-fittingly and/or force-fittingly held in a guide channel of the mounting profile. This allows the displacement device to be advantageously adjusted, the drive element to be pre-tensioned and adapted to the weight of the single-part or multi-part door connected to the mounting profile. The deflection unit is preferably slidable parallel to the longitudinal axis of the mounting profile and can be fixed in a suitable position with a locking screw. For example, the body of the deflection unit engages form-fittingly in the guide channel and is clamped therein by means of the locking screw. Due to the length of the guide channel, which preferably extends over the entire length of the mounting profile, there is a correspondingly large adjustment range that can be covered by moving the deflection unit with a hand movement.

The pull cord connection is preferably located on a stop device comprising a stop buffer mounted in the upper or lower guide rail and forming an end stop for the upper or lower guide carriage.

Preferably, two drive devices are provided, which are fixedly connected to the mounting profile or each of the guide carriages and are displaceable together with the mounting profile, and which each have a pull cord, which is led from the associated drive device directly or via a first deflection roller or via the first deflection roller and a second deflection roller to an associated pull cord connection, which is arranged stationary at the first or second end position of the driveway, and is connected thereto.

In a further preferred embodiment, the mounting profile is connected to an auxiliary drive which has an extendable piston supported by a spring element and which abuts against a stop device after the mounting profile enters the door compartment. The spring element of the auxiliary drive is tensioned as soon as the mounting profile moves towards the first end position inside the door compartment. After reaching the end position, the spring element of the auxiliary drive is loaded and can support the drive device at the beginning of the drive of the mounting profile towards the second end position. The drive device and the auxiliary drive therefore complement each other ideally. The auxiliary drive is therefore used over a short distance of 2 cm-10 cm for rapid acceleration of the door from the end position, while the main drive continues to move the mounting profile over the entire driveway.

The mounting profile is preferably connected to a cyclically operating locking device, which comprises an actuating rod and a gripper, which interacts with a stationary mounted gripping element and is cyclically lockable and unlockable by pressure on the actuating rod. By a first displacement of the actuating rod, which is supported by a spring, the gripper is closed and by a second displacement of the actuating rod the gripper is opened again. The actuating rod is preferably arranged coaxially to the central axis of the gripper, so that the actuating rod can be actuated by the gripping element, which is gripped by the gripper and released again.

Preferably, the locking device comprises a locking body which has a locking groove on one or both sides in which a locking element engages. The locking groove preferably revolves around a central locking part and is designed in such a way that the associated locking element is cyclically guided around the locking part in the same direction during movements of the actuating rod and engages once in a locking area and is released again from the locking area during each revolution. When reaching the first end position inside the door compartment, the locking device is therefore actuated and held by the gripper. By pressing on the mounted door, the actuating rod is moved, and the gripper is released again. The door can therefore be locked inside the door compartment by one push and released by another push.

The inventive displacement device can be used for any functional entity comprising a lockable space, which is usually delimited by walls or partitions. The functional entities can have spaces delimited by wooden walls and can relate to pieces of furniture, in particular wardrobes. However, functional entities can also have spaces delimited by walls, which can be locked by means of single-part or multi-part doors, possibly foldable sliding doors.

The holding device can be easily adapted to the size of the door compartment and always interact optimally with the mounting profile. If a longer mounting profile has to be moved over a longer distance in a larger door compartment, only longer holding cables have to be provided.

The holding cables can be guided close to the guide rails and, when changing from the upper to the lower guide rail or from the lower to the upper guide rail, preferably run at a short distance from the mounting profile. During these changes of direction, the holding cables typically cross approximately in the middle of the mounting profile. The space inside the door compartment is practically only occupied by the rod-shaped mounting profile.

By avoiding a scissor cross, the inventive displacement device can be compactly constructed. The door compartment can accommodate larger single-part or multi-part doors, possibly foldable sliding doors, which are connected to the mounting profile by mounting hinges.

A functional entity can have one or more door compartments. For example, door compartments are provided on both sides of the functional entity, which delimit the usable space of the functional entity. A door compartment can also have two displacement devices with single-part or multi-part doors, possibly foldable sliding doors, by means of which a usable space of the functional entity can be closed off on both sides of the door compartment.

The invention is explained in more detail below with the reference to the drawings. Thereby shows:

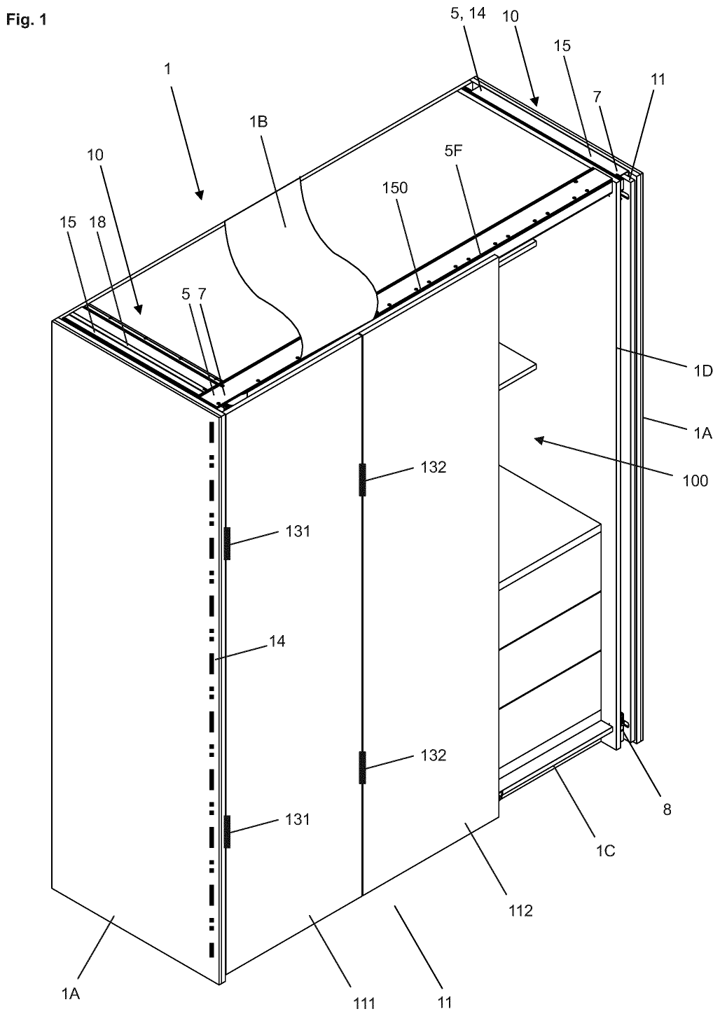

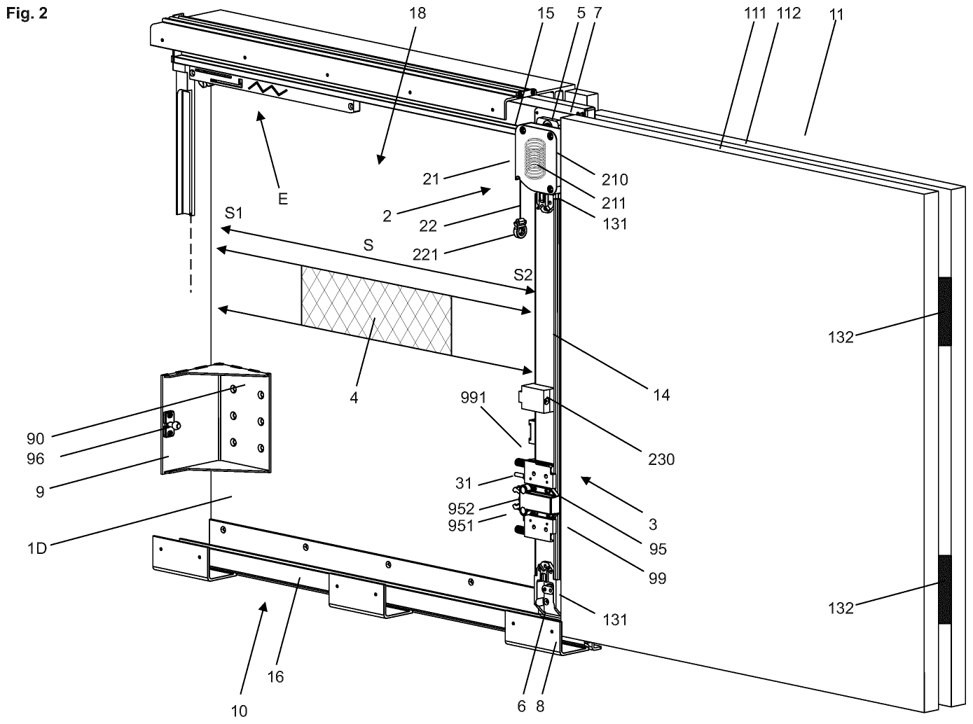

FIG. 1 an inventive functional entity 1 in the form of a piece of furniture with a first door compartment 18, in which a mounting profile 14 of an inventive displacement device 10, which is connected to a foldable sliding door 11, is held displaceably by means of a holding device 4, and a second door compartment 18, in which a further mounting profile 14 of an inventive displacement device 10, which is connected to a single-part door 11, is held displaceably by means of a holding device 4 (see FIG. 2)

FIG. 2 the displacement device 10 arranged in the first door compartment 18 of the functional entity 1 of FIG. 1 with the mounting profile 14, which is optionally connected to a drive device 2 and/or optionally connected to an auxiliary drive 3, which is connected to the foldable sliding door 11 by mounting hinges 131 and which is held in vertical alignment by the holding device 4 (schematically shown);

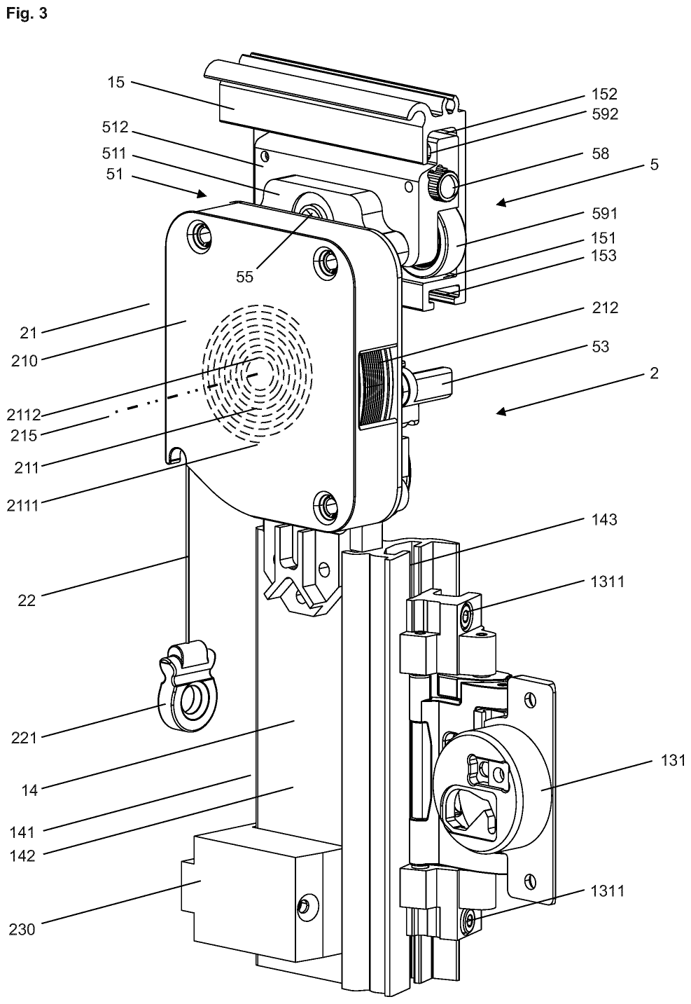

FIG. 3 a part of the displacement device 10 of FIG. 2 with the upper end piece of the mounting profile 14, which is connected to an upper guide carriage 5, which is slidably supported in an upper guide rail 15 and which is connected to a preferably provided drive device 2, which holds a pull cord drum 212, around which a pull cord 22 is wrapped;

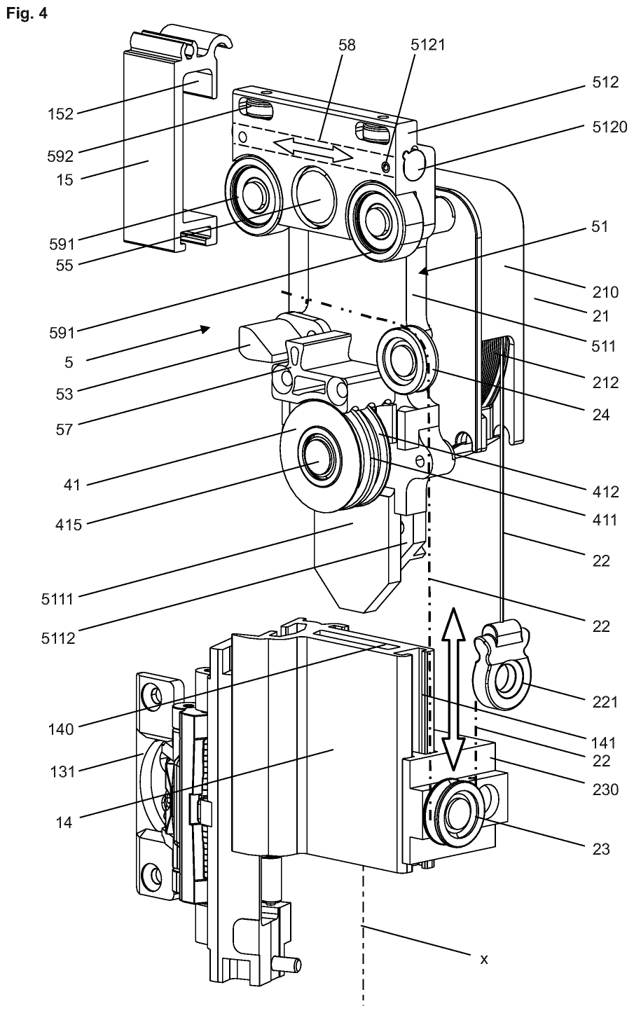

FIG. 4 the upper guide carriage 5 of FIG. 3, from the other side and detached from the mounting profile 14, to which a deflection unit 230 with a first deflection roller 23 is slidably and fixably held, with an upper roller pair 41 of the holding device 4 held by an upper bearing shaft 415;

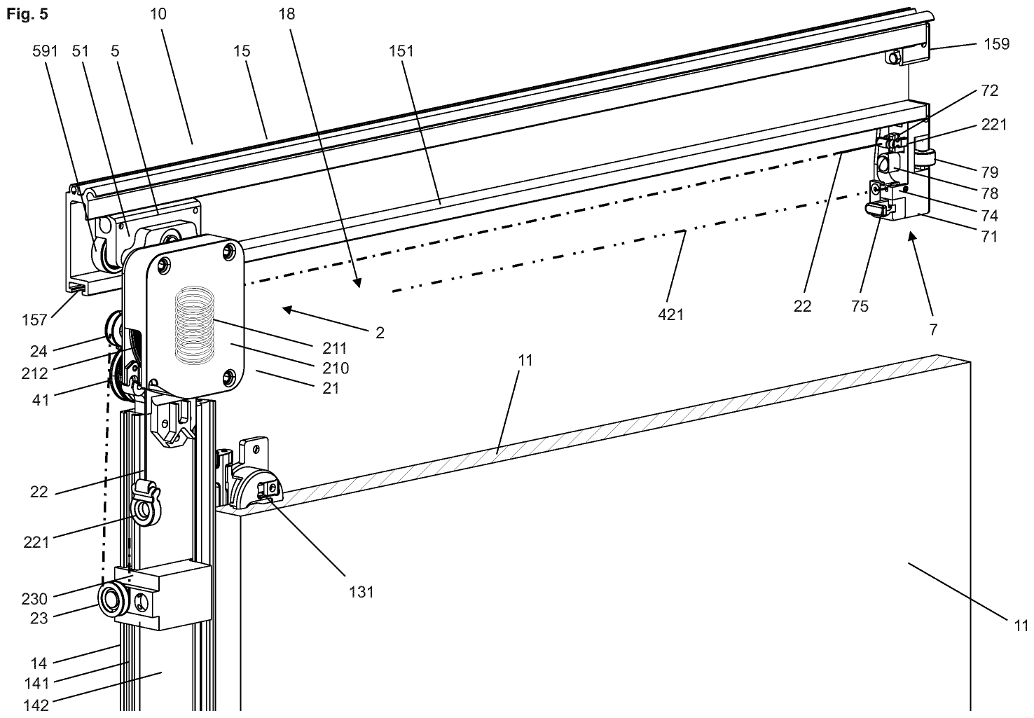

FIG. 5 the upper part of the displacement device 10 of FIG. 2 with a first holding cable 421 of the holding device 4 and the optional drive device 2, from which a pull cord 22 is led via a first deflection roller 23 of a deflection unit 230, which is slidably connected to the mounting profile 14, and a second deflection roller 24, which is connected to the upper guide carriage 5, to a pull cord connection 72 on an upper stop device 7, which is held on the front side of the upper guide rail 15;

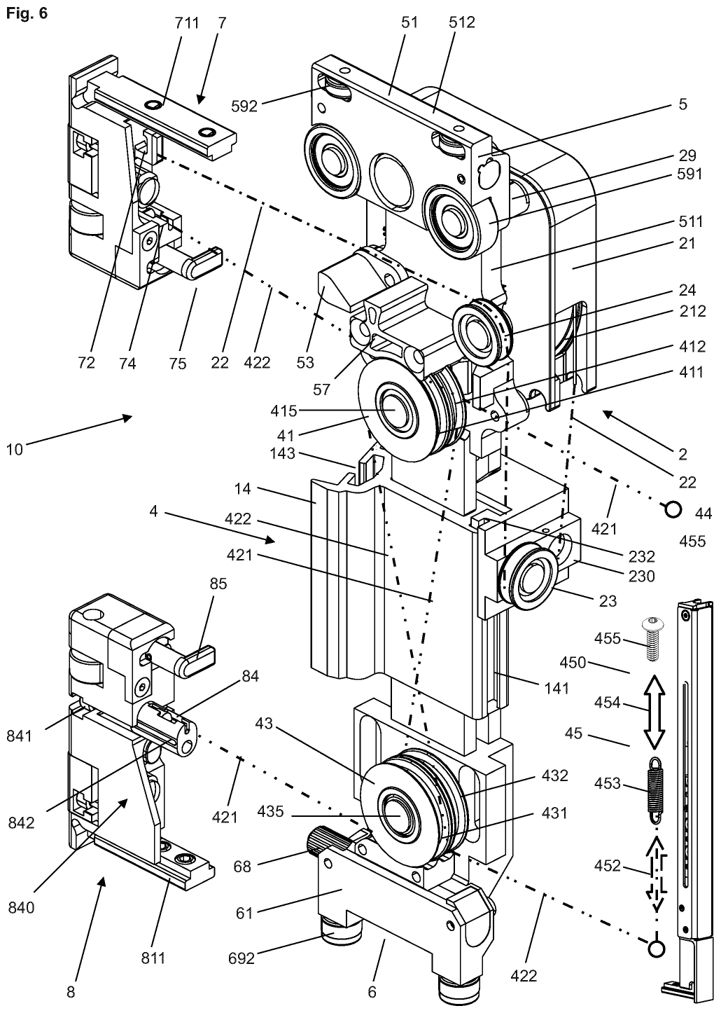

FIG. 6 the displacement device 10 of FIG. 2 with the inventive holding device 4 in a first preferred embodiment with the first holding cable 421 connected to a first front-sided cable connection device 84 and a first rear-sided cable connection device 44, and with a second holding cable 422 connected to a second front-sided cable connection device 74 and a second rear-sided cable connection device 45, wherein the second holding cable 422 is resiliently held by a tensioned second pull spring 453;

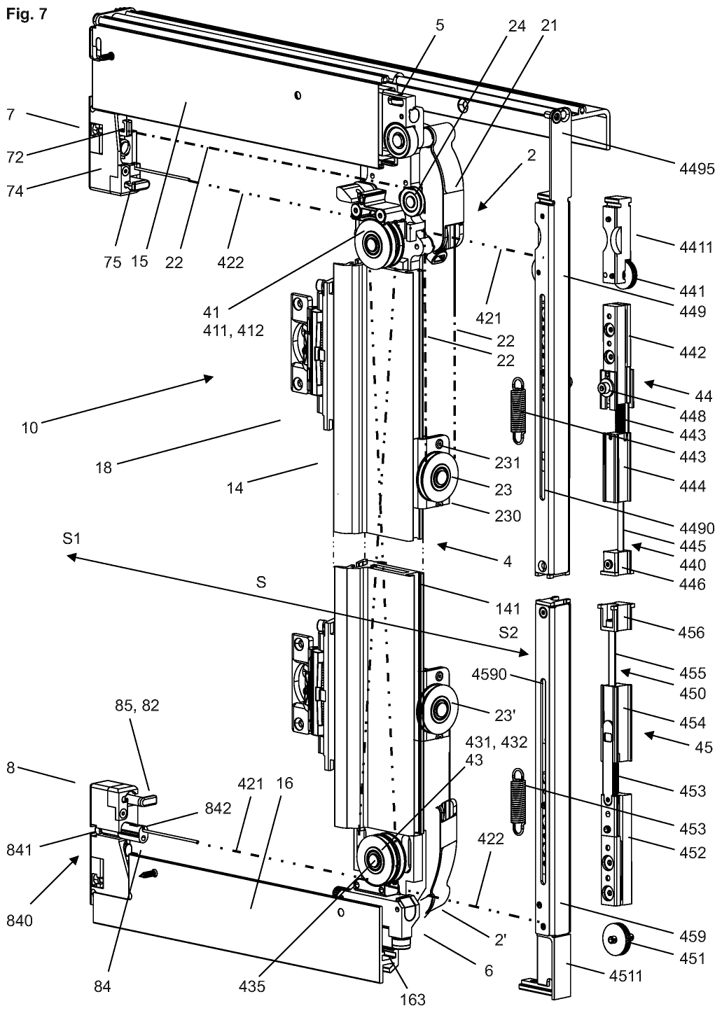

FIG. 7 in a preferred embodiment the displacement device 10 of FIG. 6 with the rear-sided cable connection devices 44, 45, to which the holding cables 421, 422 of the holding device 4 are guided;

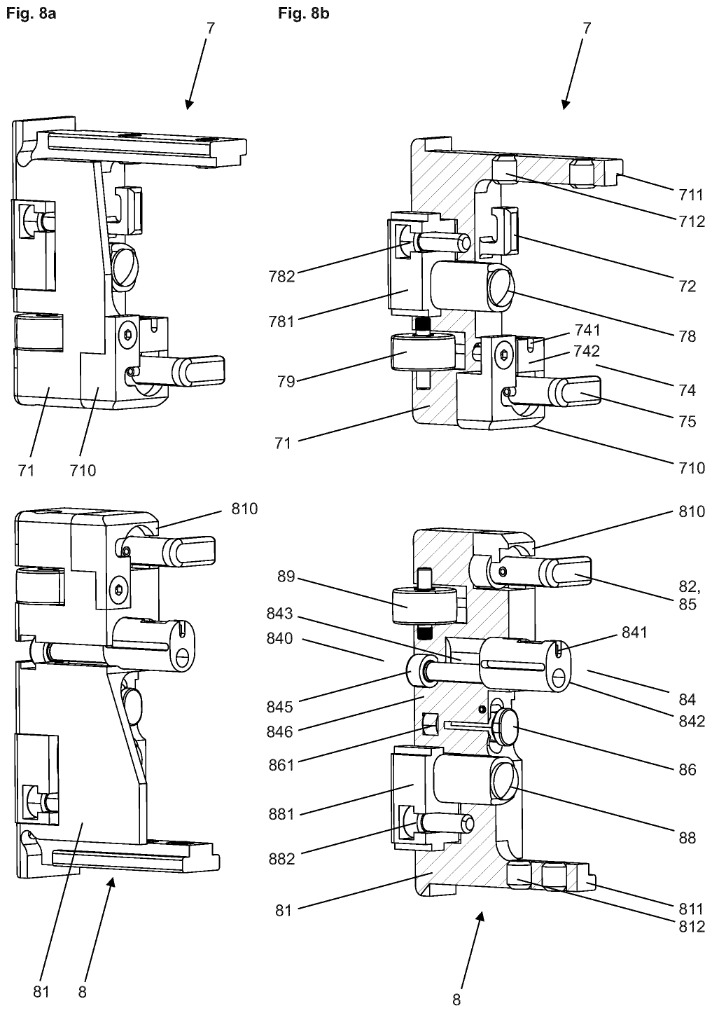

FIG. 8a the upper stop device 7 and the lower stop device 8 of FIG. 7 in spatial representation;

FIG. 8b the upper stop device 7 and the lower stop device 8 of FIG. 7 in sectional view;

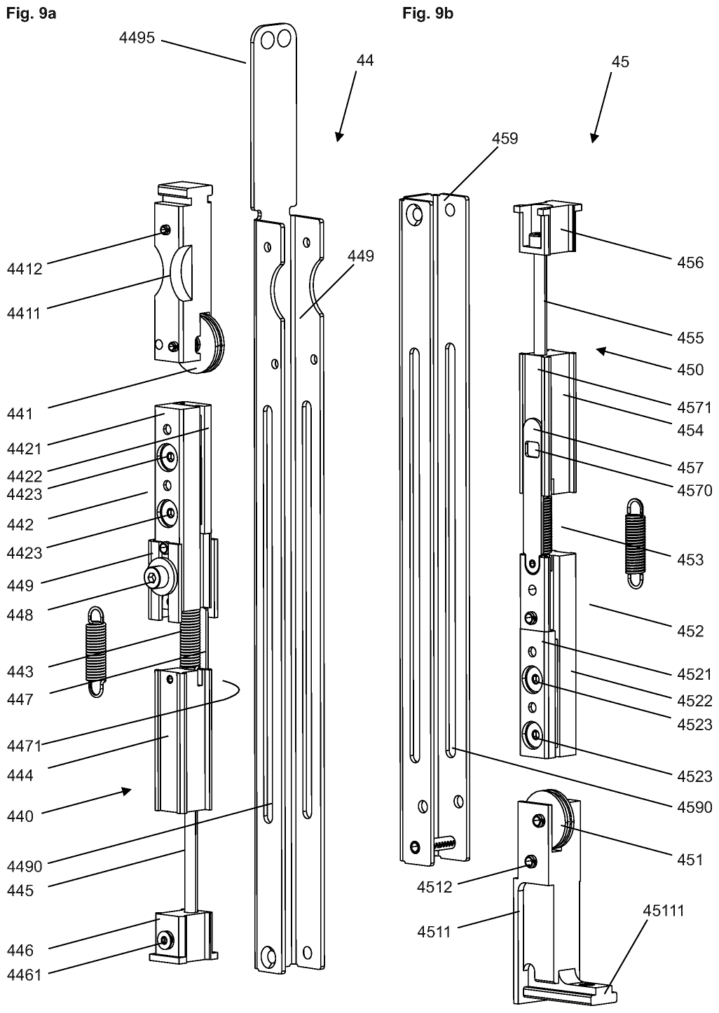

FIG. 9a the upper rear-sided cable connection device 44 of FIG. 7;

FIG. 9b the lower rear-sided cable connection device 45 of FIG. 7;

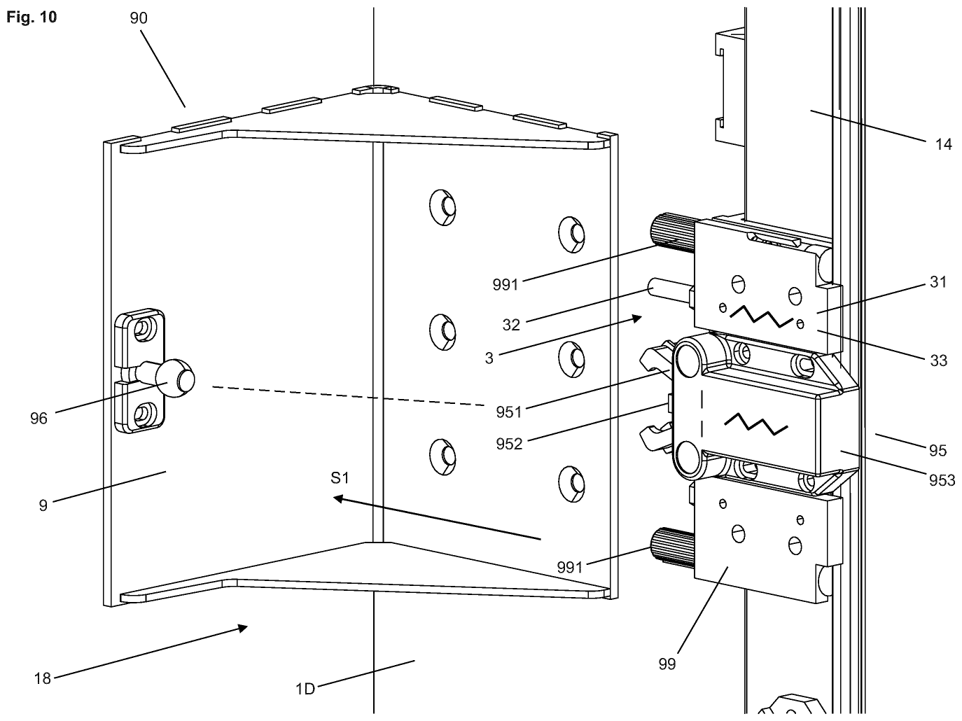

FIG. 10 the auxiliary drive 3 of FIG. 2, which is held by the mounting profile 14 and which cooperates with a rear-sided end stop 9 after the sliding door 11 has been pushed into the door compartment 18; and

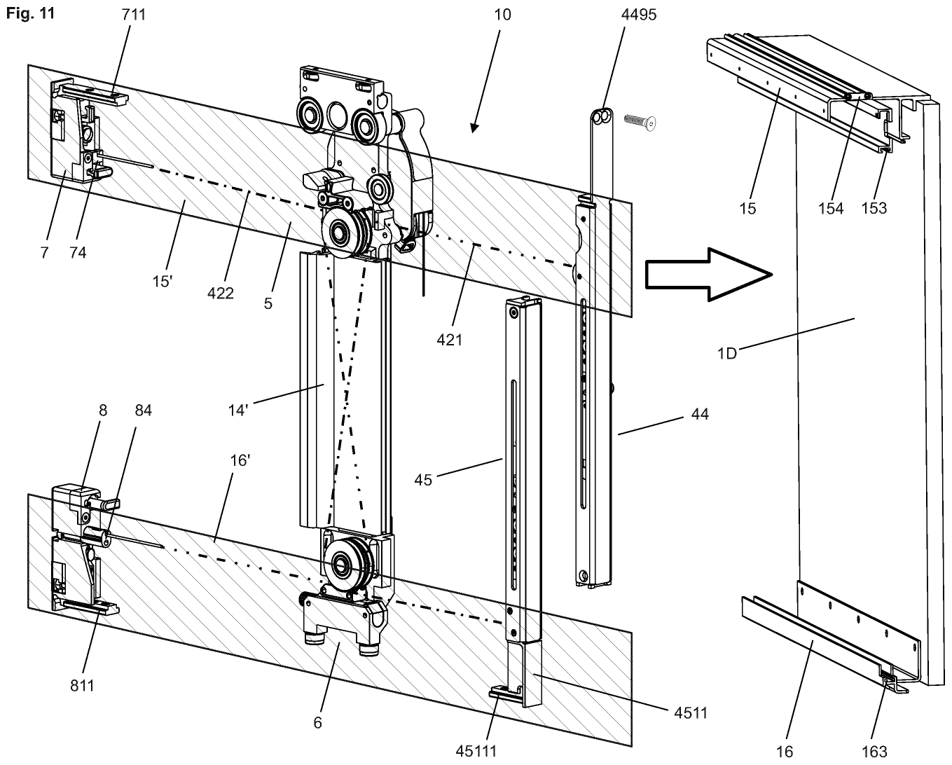

FIG. 11 an assembly configuration of the displacement device 10 provided for installation purposes, which comprises a mounting profile substitute 14′ holding the upper guide carriage 5 and the lower guide carriage 6, which comprises an upper guide rail substitute 15′ holding the upper stop device 7 and the first rear-sided cable connection device 44 and is connected to the upper guide carriage 5 and which comprises a lower guide rail substitute 16′ holding the lower stop device 8 and the second rear-sided cable connection device 45 and connected to the lower guide carriage 6, and which comprises the mounted holding cables 421, 422, and with one of the intermediate walls 1D of FIG. 1, to which the lower and upper guide rails 15, 16 are already mounted and to which the displacement device 10 in the assembly configuration is transferred.

FIG. 1 shows an inventive functional entity or a piece of furniture 1 in the form of a wardrobe in which a door compartment 18 is integrated on each side. The piece of furniture 1 comprises side walls 1A, an upper board 1B, a lower board 1C and partitions 1D, which each delimit a door compartment 18 together with an associated side wall 1A. In each door compartment 18, an inventive displacement device 10 with a mounting profile 14 is arranged, which in preferred embodiments is automatically displaceable within the door compartment 18. The mounting profile 14 holds doors 11, which are retracted into or moved out of the associated door compartment 18 when the mounting profile 14 is displaced.

A foldable sliding door 11 is held in the first door compartment 18, which has a first and a second door element 111, 112 that are hinged to each other. The door 11 held inside the second door compartment 18 by a mounting profile 14, on the other hand, has only one door element 111.

The foldable sliding door 11 is fully extracted from the first door compartment 10 and fully unfolded so that the door elements 111, 112 are aligned in one plane. The door elements 111, 112 of the foldable sliding door 11 and the door element 111 of the single-part door 11 are of equal size. Hence, the foldable sliding door 11 shown in the closed position covers two thirds of the cabinet opening 100.

The trailing edge of the first door element 111 is connected by mounting hinges 131 to the mounting profile 14 shown symbolically, which is held at the exit of the door compartment 18 after the foldable sliding door 11 has been moved out.

The leading edge of the first door element 111 is connected by door hinges 132 to the trailing edge of the second door element 112, the leading edge of which is connected at the top to a front carriage 5F. The front carriage 5F is guided in a support rail 150, which comprises rail elements interconnected by curved sections, one of which extends into the associated door compartment 18 and one of which extends along the front of the piece of furniture 1. When entering the door compartment 18 and when travelling along the front of the piece of furniture 1, the front carriage 5F runs in front, whereby the change of direction takes place within the curved section.

FIG. 2 shows the displacement device 10 arranged in the first door compartment 18 of the functional entity 1 of FIG. 1 with a holding device 4 according to FIG. 6 or FIG. 7 (shown schematically in FIG. 2), by which the mounting profile 14 is held displaceably in vertical alignment.

Optionally, the mounting profile 14, which is held in vertical orientation by the holding device 4 and which is connected to the foldable sliding door 11 by the mounting hinges 131, is connected to a drive device 2 and to an auxiliary drive 3.

The mounting profile 14 is displaceable along a driveway S between a first end position S1 at the rear of the door compartment 18 and a second end position S2 at the front of the door compartment 18.

As further described below with reference to FIG. 6, the mounting profile 14 is connected at the upper end to an upper guide carriage 5 guided in an upper guide rail 15 and at the lower end by a lower guide carriage 6 guided in a lower guide rail 16. The upper guide carriage 5 comprises support rollers 591 and guide rollers 592 and, in addition to its guiding function, also has a supporting function. The lower guide carriage 6 comprises guide rollers 692, which are guided in the lower guide rail 16.

The upper guide carriage 5 and the lower guide carriage 6 abut at the second end position S2 on an upper stop device 7 and on a lower stop device 8 in FIG. 2, which are explained in more detail below with reference to FIG. 6 and FIG. 8a and FIG. 8b.

At the rear-sided first end position S1, a stop device 90 is provided with a stop or stop plate 9 which restricts the driveway S of the mounting profile 14 at the rear of the door compartment 18.

The inventive displacement device 10 preferably comprises a drive device 2 with a pull cord 22, which is not yet mounted in FIG. 2. By means of this drive device 2, the mounting profile 14 is preferably displaceable over the entire driveway S.

An even more advantageous movement of the mounting profile 14 can be achieved if a drive device 2 is not only provided at the upper end of the mounting profile 14 or at the upper guide carriage 5, but also at the lower end of the mounting profile 14 or at the lower guide carriage 6. It is desirable to have a high acceleration at the beginning and a smooth movement of the mounting profile 14 afterwards.

Optionally, an auxiliary drive 3 is provided, by means of which the at least one drive device 2 is assisted in the area of the rear-sided first end position S1. As soon as the mounting profile 14 is released from the rear-sided end position S1 or from the stop plate 9, it is additionally accelerated over a relatively short distance by the auxiliary drive 3. With the auxiliary drive 3, a rapid movement sequence is realised. The mounting profile 14 does not move sluggishly from the end position S1 but is accelerated quickly.

Above and below the auxiliary drive 3, damping devices 99 are provided, comprising a damper piston 991, which is displaced when hitting the stop plate 9 and which damps the movement of the mounting profile 14 and avoids a disturbing impact.

A cyclically operating locking device 95 is also provided between the two damping devices 99, comprising an actuating rod 952 and a gripper 951 which can cooperate with a stationary mounted gripping element 96 and which can be cyclically locked and unlocked by pressure on the actuating rod 952 exerted by means of the gripping element 96 when the first end position S1 is reached (see FIG. 11). By manual or motorised pressure on the locking device 95, it can thus be locked and unlocked again by further pressure.

FIG. 2 further shows a pull-in device E, by means of which the mounting profile 14 or one of the guide carriages 5, 6 can be gripped and pulled to the first end position S1. The inventive holding device 4 can therefore be used without or optionally in combination with one or more drive devices 2, E.

FIG. 3 shows a part of the displacement device 10 of FIG. 2 with the upper end piece of the mounting profile 14 connected to an upper guide carriage 5 which is slidably mounted in an upper guide rail 15 and which is connected to a drive device 2. The drive device 2 comprises a drive unit 21 with a housing 210, in which a drive element 211 is provided and a pull cord drum 212 connected thereto, on which a pull cord 22 is wound, is rotatably held. The drive element 211 is preferably a power spring, such as a coil spring or a helical spring, which is tensioned or released when the pull cord drum 212 is rotated. The pull cord drum 212 is rotatably mounted by means of a bearing shaft 215 (shown schematically). The spiral-shaped drive element 211 also surrounds the bearing shaft 215 and is firmly connected with a first end piece 2111 to the pull cord drum 212 and with a second end piece 2112 to the bearing shaft 215. Therefore, when the pull cord drum 212 is rotated while pulling out the pull cord 22, the first end piece 2111 of the drive element 211 is guided around the bearing shaft 215 while the second end piece 2112 of the drive element 211 is held in place. As soon as the pull cord 22 is released, the pull cord drum 212 is turned back again by the tensioned drive element 211. If the coupling element 221 is hooked onto a pull cord connection at the front end of the pull cord 22, for example, and the mounting profile 14 is retracted into the door compartment 18, the pull cord 22 is pulled out of the drive unit 21, the pull cord drum 212 is turned and the drive element 211 is tensioned. The mounting profile 14 can now be locked with the locking device 95 when reaching the second end position S2. As soon as this locking device is released, the pull cord drum 212 is turned back by the drive element 211 and the pull cord 22 is retracted again and the mounting profile 14 is moved from the second end position S2 to the first end position S1. A door 11 connected to the mounting profile 14 is therefore automatically moved out of the door compartment 18.

By connecting the drive device 2 to the mounting profile 14 or the guide carriage 5, mounting on a rear wall, a partition wall 1D or a side wall 1A of the functional entity 1 is no longer necessary. It is particularly advantageous that the displacement device 10 can be installed in differently dimensioned door compartments 18 without modification. As described below, adjustments and settings can be made with minimal effort. Even if the displacement device 10 is provided with a drive device 2 on the upper side of the mounting profile 14 and a drive device 2 on the lower side of the mounting profile 14, the mounting of the displacement device 10 can be performed with minimal effort.

FIG. 3 further shows that the mounting profile 14 has two guide channels 141, 142 and a mounting channel 143, in which the mounting hinges 131 are form-fittingly held and can be fixed by locking screws 1311.

At least one of the guide channels 141, 142 is used to hold a deflection unit 230, which can be moved along the mounting profile 14 and fixed in place by means of locking screws.

The upper guide carriage 5 comprises a two-part carriage body 51 with a first carriage body part 511 and a second carriage body part 512, by which vertically aligned support rollers 591 and horizontally aligned guide rollers 592 are held. The two carriage body parts 511, 512 may be integrally connected to each other, but in this embodiment are connected to each other by a coupling member 55. The support rollers 591 are supported on a runner element 151 of the upper guide rail 15 and the guide rollers 592 are guided in a guide channel 152 of the upper guide rail 15. A buffer or damper 58 is inserted into the carriage body 51. Furthermore, the upper guide carriage 5 comprises a stop member 53 which can cooperate with a buffer or damper on the front-sided stop device 7.

FIG. 4 shows the upper guide carriage 5 of FIG. 3 from the other side and detached from the mounting profile 14, on which a deflection unit 230 with a first deflection roller 23 is held so that it can be moved and fixed. The deflection unit 230 is form-fittingly held in a guide channel 141 or 142 and can be moved along it and locked in place. The pull cord 22 of the drive device 2 is guided around the first deflection roller 23 to a second deflection roller 24, which is held by the carriage body 51 of the upper guide carriage 5. From the second deflection roller 24, the pull cord 22 is further led to a pull cord connection 72, which is arranged on the upper stop device 7 (see FIG. 5).

By moving the deflection unit 230 along the mounting profile 14, the path from the pull cord drum 212 to the second deflection roller 24 can be lengthened or shortened. By lengthening this path, a corresponding length of the pull cord 22 is pulled out of the drive unit 21, the pull cord drum 212 is rotated accordingly and the drive element 211 is pre-tensioned accordingly. The pre-tensioning of the drive element 211 therefore causes it to act with a higher tensile force on the pull cord 22 and the mounting profile 14 is moved with a higher force from the first end position S1 towards the second end position S2. This adjustment can be carried out easily in a few steps.

FIG. 4 further shows that the first carriage body part 511 comprises a downwardly directed mounting sword 5111 which is insertable into a mounting hole 140 of the mounting profile 14. A part of the mounting profile 14 is held between the mounting sword 5111 and a holding plate 5112.

The first carriage body part 511 also holds a bearing shaft 415 from which a first upper roller unit 411 and a second upper roller unit 412 are rotatably held. The first and second roller units 411, 412, which form a roller pair 41, are part of the holding device 4 explained below. Above the roller pair 41 rests a functional part 57 which secures the holding cables 421, 422 shown in FIG. 6.

In the second carriage body part 512 a damper channel 5120 is provided, in which a carriage damper 58 is arranged and fixed by means of a locking element, possibly a locking screw 5121.

FIG. 5 shows the upper part of the displacement device 10 of FIG. 2 with the drive device 2, from which the pull cord 22 is guided via the first deflection roller 23 of the deflection unit 230 which is slidably connected to the mounting profile 14 and the second deflection roller 24 connected to the upper guide carriage 5 to a pull cord connection 72 on the upper stop device 7, which is held on the front side of the upper guide rail 15.

To put the drive device 2 into operation, the coupling member 221 is grasped at the end of the pull cord 2, guided around the first and second deflection roller 23, 24 and hooked into the pull cord connection 72 of the upper stop device 7. This procedure can be carried out in a few simple steps.

The stop device 7 is held by a mounting beam 711 (see FIG. 8b) in a holding channel 157 provided at the bottom of the runner element 151 of the upper guide rail 15. Above the runner element 151, therefore, the running mechanism is provided with the support rollers 591 and the guide rollers 592 of the upper guide carriages 5 (see FIG. 3) as well as an adjustment part 159 for adjusting the damper engagement depth, which can interact with the carriage damper 58. On the underside of the runner element 151, however, the drive technology with the pull cord 22 and the holding technology of the holding device 4 with holding cables 421, 422 are provided (see also FIG. 6).

Depending on the presence of a door with one door element 111 or two door elements 111, 112, the upper stop device 7 comprises a spacer roller 79 on one or both sides, on which the held door elements 111, 112 can roll without touching the body 71 of the upper stop device 7. Furthermore, the upper stop device 7 comprises a cable connection device 74 by means of which one of the holding cables 421 of the holding device 4 is held. Furthermore, a stop damper or stop buffer 78 is provided, which can cooperate with the stop member 53 of the upper guide carriages 5 (see FIG. 4).

FIG. 6 shows the displacement device 10 of FIG. 2 with an inventive holding device 4 which comprises two holding cables 421, 422. The upper guide carriage 5 provided at the upper end of the mounting profile 14 is guided in the upper guide rail 15 and the lower guide carriage 6 provided at the lower end of the mounting profile 14 is guided in a lower guide rail 16. On the front side of the upper guide rail 15 the upper stop device 7 and on the front side of the lower guide rail 16 the lower stop device 8 is shown (see also FIG. 7). In FIG. 6 the guide rails 15, 16 are not shown.

The upper front-sided stop device 7 with the mounting beam 711, the pull cord connection 72 and the cable connection device 74 for the second holding cable 422 have already been explained with reference to FIG. 5. The rotary lever 75 is used to hold the mounting profile 14 in the front-sided end position S2. In this position the mounting profile 14 is held vertically aligned so that the door 11 or the door elements 111, 112 can be mounted particularly easily. The upper cable connection device 74 comprises a mounting channel 741 (see FIG. 8b) with an adjacent recess into which an end piece of the upper holding cable 422 can be inserted.

The lower stop device 8 and the upper stop device 7 are described below with reference to FIG. 8a and FIG. 8b. The pull cord connection 74 of the upper stop device 7 holds the second pull cord 422. The pull cord connection 84 of the lower stop device 8 comprises a setting sledge 842 which is slidably mounted and adjustable by means of a setting screw 845. The setting screw 845 and the setting sledge 842 form a setting device 840. By operating the setting screw 845, the first holding cable 421 can be tightened or loosened and the mounting profile 14 can be aligned vertically.

The holding device 4 comprises a first front-sided cable connection device 84, a first lower roller unit 431 disposed at the lower end of the mounting profile 14, a first upper roller unit 411 disposed at the upper end of the mounting profile 14, and a first rear-sided cable connection device 44 disposed at the rear-sided end of the upper guide rail 15, and the first holding cable 421 connected by a first end piece to the first front-sided cable connection device 84, routed counterclockwise around the first lower roller unit 431 and clockwise around the first upper roller unit 411, and connected by a second end piece to the first rear-sided cable connection device 44.

Further, the holding device 4 comprises a second front-sided cable connection device 74, a second upper roller unit 412 disposed at the upper end of the mounting profile 14, a second lower roller unit 432 disposed at the lower end of the mounting profile 14, and a second rear-sided cable connection device 45 disposed at the rear-sided end of the lower guide rail 16, and the second holding cable 422 connected by a first end piece to the second front-sided cable connection device 74, routed clockwise around the second upper roller unit 412 and counterclockwise around the second lower roller unit 432 and connected by a second end piece to the second rear-sided cable connection device 45.

The first front-sided cable connection device 84 in this preferred embodiment is provided at the front-sided end of the lower guide rail 16 on the lower stop device 8. The second front-sided cable connection device 74 is arranged in this preferred embodiment at the front-sided end of the upper guide rail 15 at the upper stop device 7.

The second rear-sided cable connection device 45 comprises a second tensioning device 450 with a second pull spring 453, which on the one hand is connected directly or via a second connection sledge 452 (shown with dashed line) to the second holding cable 422 and which on the other hand is connected to a second pull sledge 454, into which a stationarily held second tensioning screw 455 is screwed, by means of which the second pull sledge 454 is displaceable within a second bearing profile 459 along its longitudinal axis in order to tension the second pull spring 453. During installation, the pull spring 453 is tensioned and a corresponding pulling force is transmitted to the second holding cable 422.

In the inventive holding device 4, therefore, one of the holding cables 421, 422, in this embodiment the second holding cable 422, is always held elastically. The first holding cable 421, on the other hand, is held inelastically or firmly by the first front-sided cable connection device 84 and the first rear-sided cable connection device 44 after installation. The vertical alignment of the mounting profile 14 can be carried out by means of the first setting device 840, alternatively at the other end by means of a first adjusting device provided in the first rear-sided cable connection device 44.

Preferably, the second pull spring 453 is pre-tensioned or stretched by a predetermined amount. If the second pull spring 453 is connected to the pull sledge 454 on the one hand and to the connection sledge 452 on the other hand, the mutual displacement of the pull sledge 454 and of the connection sledge 452 corresponds to the tensile force in the pull spring 453. The impressed tensile force can therefore be easily determined based on this displacement. When using a connection sledge 452, the holding cable 422 can be connected more easily as described below.

With reference to FIG. 7, it is further explained that preferably a tensile force is also impressed into the first holding cable 421 before it is fixed. By impressing a tensile force into the second holding cable 422 or into the first and the second holding cable 421, 422, the advantages described above result.

The preferably provided drive device 2, which is held by the upper guide carriage 5, has already been described with reference to FIG. 3. The pull cord 22 of the drive device 2 is guided via the first deflection roller 23 and the second deflection roller 24 to the pull cord connection 72 provided on the upper front-sided stop device 7. The deflection unit 230 is form-fittingly held in the first guide channel 141 by a form element 232 and is slidable along the mounting profile 14.

FIG. 7 shows the displacement device 10 of FIG. 6 with the two rear-sided cable connection devices 44, 45 of the holding device 4, each comprising a bearing profile 449, 459 connected to the rear-sided end piece of the upper or lower guide rail 15, 16. The bearing profiles 449, 459 comprise an elongated bearing opening 4490, 4590 through which the device parts are only partially visible. The device parts provided in the bearing profiles 449, 459, which each comprise a pull spring 443, 453, have therefore been duplicated and shown separately. The pull springs 443, 453 are also shown separately.

Each of the cable connection devices 44, 45 comprises an entrance roller 441, 451, a connection sledge 442, 452, a pull spring 443, 453, a pull sledge 444, 454, a tensioning screw 445, 455 and a screw holder 446, 456 anchored in the bearing profile 449, 459 by means of which the tensioning screw 445, 455 is held. The screw holders 446, 456 are each connected to the corresponding bearing profile 449; 459 by means of a mounting screw 4461. The adjacent end piece of the associated holding cable 421, 422 is guided via the entrance roller 441, 451 to the connection sledge 442, 452, which is connected by the pull spring 443, 453 to the pull sledge 444, 454, which in turn is connected by the tensioning screw 445, 455 to the screw holder 446, 456. By tightening the tensioning screw 445, 455 the pull sledge 445, 455 is pulled against the screw holder 446, 456 and the pull spring 443, 453 is tensioned. The pulling force exerted by the pull spring 443, 453 is transmitted via the connection sledge 442, 452 to the connected holding cable 421, 422. The aforementioned parts of the cable connection devices 44, 45 therefore form tensioning devices 440, 450, by means of which a tensile force in the holding cables 421, 422 can be adjusted.

With reference to FIG. 6, it was described that the connection sledge 452 is only optionally provided in the second cable connection device 45. However, in the first cable connection device 44 of FIG. 7, which preferably also comprises a tensioning device 440, the connection sledge 442 is always present so that the first pull cord 421 can be fixed after impressing the tensile force.

If the first connection sledge 442 is fixed in the first holding cable 421 after setting the tensile force, the set tensile force is subsequently maintained. For this purpose, a locking screw 448 is provided in the connection sledge 442 of the first rear-sided cable connection device 44, which is passed through the profile opening 4490 in the bearing profile 449 and is clamped to the bearing profile 449 when tightened. Therefore, parts of the bearing profile 449 are symbolically shown below the locking screw 448.

The installation of the inventive displacement device preferably takes place as follows:
The mounting profile 14 is aligned vertically and preferably fixed. The fixing is done for example by the locking levers 75, 85 located at the stop devices 7 and 8.
The first holding cable 421 is connected with a first end piece to the first front-sided cable connection device 84, passed around the first lower or upper roller unit 431 and around the first upper or lower roller unit 411 and connected with a second end piece to the first rear-sided cable connection device 44 and manually tensioned. The roller units 411, 431 are circulated by the first holding cable 421 once clockwise and once counterclockwise, or vice versa.
The second holding cable 422 is connected with a first end piece to the second front-sided cable connection device 74, passed around the second upper or lower roller unit 412 and around the second lower or upper roller unit 432 and connected with a second end piece to the second rear-sided cable connection device 45 and manually tensioned. The roller units 412, 432 are passed around by the second holding cable 421 once clockwise and once counterclockwise, or vice versa.
The second holding cable 422 is connected in the second rear-sided cable connection device 45 to the second connection sledge 452, after which the second tensioning screw 455 is turned and the second pull sledge 454 and the second connection sledge 452, which are connected to each other by the second pull spring 453, are displaced relative to each other by a predetermined amount.
The first front-sided setting sledge 842 of the first front-sided setting device 840 of the first front-sided cable connection device 84, which is connected on one side to the fixed first holding cable 421, is now adjusted by means of the fixed setting screw 845 in order to vertically align the mounting profile 14 or to optimise the vertical alignment of the mounting profile 14, which is released before.

After completion of the installation procedure, a predetermined tension is impressed in the second holding cable 422 and the mounting profile 14 is vertically aligned by means of the tensioned first holding cable 421.

This installation process is optimised by impressing a predetermined tensile force in the first holding cable 421 before adjusting or vertically aligning the mounting profile 14. After impressing a predetermined tensile force in both holding cables 421, 422, the effort for adjusting or vertical alignment of the mounting profile 14 is reduced.

In preferred implementations of the installation method, the first holding cable 421 in the first rear-sided cable connection device 44 is additionally connected to the first connection sledge 442, after which the first tensioning screw 445 is turned and the first pull sledge 444 and the first connection sledge 442, which are connected to each other by the first pull spring 443, are displaced relative to each other by a predetermined amount.

After this step, the predetermined tensile forces are imprinted in both pull sledge 421, 422. These adjustments are preferably made in accordance with the measuring rods, which indicate the degree of mutual displacement of the connection sledge 442, 452 and the pull sledge 444, 454 preferably on a scale with markings, possibly colour markings.

The first connection sledge 442 is fixed to the corresponding first bearing profile 449 after impressing the predetermined tensile stress. Then, as described, the first front-sided setting device 840 is actuated to vertically align the mounting profile 14, which is no longer fixed. Usually, only minimal corrections will be necessary.

FIG. 7 shows symbolically that optionally a second drive device 2′ and a second sliding deflection unit with a first deflection roller 23′ can also be provided on the underside of the mounting profile 14. The lower pull cord would in turn be led via the first deflection roller 23′ and a deflection roller, which is attached to the lower guide carriage 6, for example, to a pull cord connection 82 on the lower stop device 8. A second drive device 2′ and the corresponding device parts can therefore be provided practically as a mirror image of the first drive device 2 with minimal effort.

FIG. 8a shows the upper stop device 7 and the lower stop device 8 of FIG. 7 in spatial representation. FIG. 8b shows the upper stop device 7 and the lower stop device 8 of FIG. 7 in sectional view.

The upper stop device 7 and the lower stop device 8 each comprise a device body 71, 81 and a mounting beam 711, 811 formed thereon, which can be arrested in the associated upper or lower guide rail 15, 16 by means of locking screws 712, 812. The upper stop device 7 comprises a hook-shaped pull cord connection 72, in which the coupling member 221 of the pull cord 22 can be hooked.

Furthermore, each stop device 7, 8 preferably comprises a spacer roller 79, 89 on both sides, which keeps the passing door 11 at a distance, and a rotatable locking lever 75, 85, by means of which the mounting profile 14 can be fixed at the front in order to carry out installation work, maintenance work or adjustments. If a second drive device 2′ is provided, the locking lever 85 could also be used as a pull cord connection 82. The locking lever 75, 85 are held by a retaining shell 710, 810, which is connected to the device body 71, 81 by a screw.

Furthermore, each stop device 7, 8 comprises a preferably adjustable stop buffer 78, 88 with a buffer body 781, 881 and an adjustment screw 782, 882.

The cable connection device 74 of the upper stop device 7 is simple and comprises a retaining block 742 with an upwardly open mounting channel 741 into which an end piece of the second holding cable 422 can be hooked.

The lower stop device 8 comprises a cable connection device 84 with a setting device 840 formed by a slidable setting sledge 842 and a setting screw 845 by means of which the setting sledge 842 is slidable within a bearing profile 843. The setting sledge 842 comprises a mounting channel 841 into which the end piece of the first holding cable 421 can be hooked.

Furthermore, the lower stop device 8 comprises a plunger 86 which is axially displaceable by means of an adjustment screw 861 and which can cooperate with the integrated carriage damper 68 of the lower guide carriages 6.

FIG. 9a shows the upper rear-sided cable connection device 44 and FIG. 9b shows the lower rear-sided cable connection device 45, which have already been briefly described with reference to FIG. 7.

The entrance roller 441 of the upper rear-sided cable connection device 44 is held by a roller holder 4411, which can be tensioned within the bearing profile 449 by means of a tensioning element 4412. The entrance roller 451 of the lower rear-sided cable connection device 45 is held by a roller holder 4511, which can be tensioned within the bearing profile 459 by means of a tensioning element 4512.

The optional connection sledges 442, 452 comprise clamping jaws 4421, 4422 and 4521, 4522, respectively, which can be pressed against each other by clamping screws 4423, 4523 in order to fix the end piece of the respective holding cable 421, 422 inserted in between. The holding cables 421, 422 can therefore be pulled through the connection sledge 442, 452, manually tensioned and fixed.

Further shown is the locking screw 448, by means of which the first connection sledge 442 can be fixed to the corresponding first bearing profile 449. After the first connection sledge 442 has been fixed, the first pull spring 443 has no further effect. Subsequently, the elasticity of the holding device 4 is determined by the still active pull spring 453 of the second cable connection device 45.

As stated, the mentioned parts of the cable connection devices 44, 45 form tensioning devices 440, 450, by means of which a tensile force in the holding cables 421, 422 can be adjusted. A measuring rod 447, 457 with a control window 4570 is provided for setting a desired tensile force. The measuring rod 457 is connected to the connection sledge 452 and overlaps a scale 4471, 4571 provided on the pull sledge 444, 454. The mutual displacement of the connection sledge 442, 452 and of the pull sledge 444, 454, which are slidably mounted in the bearing profile 449, 459, can therefore be read by means of the measuring rods 447, 457.

FIG. 10 shows the auxiliary drive 3 of FIG. 2, which is held by the mounting profile 14 and which cooperates with a rear-sided end stop 9 after the sliding door 11 has been pushed into the door compartment 18. The auxiliary drive 3 comprises a housing 33 and at least one extendable piston 32, which is supported by a spring element 31 and which engages the end stop 9 after the mounting profile 14 has entered the door compartment 18. The spring element 31 of the auxiliary drive 3 is tensioned as soon as the mounting profile 14 moves towards the first end position S1 inside the door compartment 18. After reaching the end position, the spring element 31 of the auxiliary drive 3 is loaded and can support the drive device 2 at the beginning of the drive of the mounting profile 14 towards the second end position S2.

The mounting profile 14 is further connected to a cyclically operating locking device 95 comprising an actuating rod 952 and a gripper 951 which cooperates with a stationary mounted gripping element 96 and which is cyclically lockable and releasable by applying pressure to the actuating rod 952. By a first displacement of the actuating rod 952, which is arranged in a device housing 953 and supported by a spring, the gripper 951 is closed and by a second displacement of the actuating rod 952 the gripper 951 is opened again. The actuating rod 952 is preferably arranged coaxially to the central axis of the gripper 951, so that the actuating rod 952 can be actuated by the gripping element 96, which is gripped and released by the gripper 951. The gripping element 96 is arranged on the stop plate 9 of the stop device 90, which is attached to the intermediate wall 1D of the functional entity 1. The displacement path of the actuating rod 952 is indicated by a dotted line. Shortly before reaching the end position S1, it meets the gripping element 96 and is pushed back by it, whereby the gripping device 95 is actuated and coupled to the gripping element 96.

Furthermore, damping devices 99 with damper pistons 991 are provided, which hit the stop plate 9 as soon as the mounting profile 14 reaches the end position S1.

The auxiliary drive 3, the gripping device 95 and the damping devices 99 are optional and can be replaced by functionally equivalent devices.

FIG. 11 shows an assembly configuration of the displacement device 10 comprising a mounting profile substitute 14′ releasably holding the upper guide carriage 5 and the lower guide carriage 6, an upper guide rail substitute 15′ releasably holding the upper stop device 7 and the first rear-sided cable connection device 44 and being connected to the upper guide carriage 5, a lower guide rail substitute 16′ releasably holding the lower stop device 8 and the second rear-sided cable connection device 45 and being connected to the lower guide carriage 6, and the pre-assembled holding cables 421, 422.

The holding cables 421, 422 are connected at the front to the cable connection devices 74, 84 of the stop devices 8, 7 and at the rear to the cable connection devices 44, 45.

FIG. 11 also shows one of the partitions 1D of FIG. 1, on which the lower and upper guide rails 15, 16 are already mounted and to which the displacement device 10 in the assembly configuration is transferred. The installation can be carried out particularly easily if the intermediate wall 1D is aligned horizontally.

To install the displacement device 10 in the assembly configuration, it is therefore only necessary to replace the mounting profile substitute 14′ with the mounting profile 14 and the upper and lower guide rail substitute 15′, 16′ with the upper and lower guide rails 15, 16. Subsequently, the described steps for tensioning the holding cables 421, 422 and for aligning the mounting profile 14 can be carried out.

The assembly configuration of the displacement device 10 can therefore be advantageously created by the manufacturer, while the installation of the displacement device 10 at the installation site can be carried out by the user almost without instructions in a simple manner, for example with the installation steps described below.

Preferably, the mounting profile substitute 14′ is replaced by the mounting profile 14 in a first installation step.

In a second installation step, the guide carriages 5, 6, which are now connected to the mounting profile 14, are inserted into the corresponding upper or lower guide rails 15, 16 that are connected to the partition 1D.

In a third installation step, the stop devices 7, 8 are detached from the upper and lower guide rail substitute 15′, 16′ and inserted into the upper and lower guide rails 15, 16. The mounting beam 711 of the upper stop device 7 is inserted into the mounting channel 153 of the upper guide rail 15 and the mounting beam 811 of the lower stop device 8 is inserted into the mounting channel 163 of the lower guide rail 16.

In a fourth installation step, the rear-sided cable connection devices 44, 45 are detached from the upper and lower guide rail substitutes 15′, 16′ and connected to the upper and lower guide rail 15, 16. For this purpose, a mounting strip 4495 of the first rear-sided cable connection device 44 is screwed to a mounting connection 154 of the upper guide rail 15. The second rear-sided cable connection device 45 is inserted into the mounting channel 163 of the lower guide rail 16 with a mounting beam 45111, which is connected to the corresponding roller holder 4511.

In a final installation step, the upper guide rail substitute 15′ is detached from the upper guide carriage 5 and the lower guide rail substitute 16′ from the lower guide carriage 6.

After these installation steps, which are also interchangeable, the inventive displacement device 10 is connected to the upper and lower guide rails 15, 16 alone.

Subsequently, the holding cables 421, 422 are tensioned as already described.

### LIST OF REFERENCES

1 functional entity, piece of furniture or room unit
1A side walls
1B upper board
1C lower board
1D partition wall
10 displacement device
100 furniture opening
11 door, possibly foldable sliding door
111 first door element of the foldable sliding door
112 second door element of the foldable sliding door
131 mounting hinges
1311 locking screws
132 door hinges
14 mounting profile
14′ mounting profile substitute
140 mounting hole
141 first guide channel
142 second guide channel
143 mounting channel
15 upper guide rail
15′ upper guide rail substitute
150 support rail
151 runner element
152 guide channel
153 mounting channel
154 mounting connection
157 holding channel
159 adjustment part
16 lower guide rail
16′ lower guide rail substitute
163 mounting channel
18 door compartment
2 drive device
21 drive unit
210 housing
211 drive element, drive spring
2111 first end piece of the drive element
2112 second end piece of the drive element
212 pull cord drum
215 bearing shaft
22 transmission medium, pull cord
221 coupling member, possibly end piece of the pull cord
23 first deflection roller
230 deflection unit
231 locking screw
232 form element
24 second deflection roller
29 connection part
3 auxiliary drive
31 drive element, drive spring
32 piston
33 housing
4 holding device
41 upper roller pair
411 first upper roller unit
412 second upper roller unit
415 upper bearing shaft
421 first holding cable
422 second holding cable
43 lower roller pair
431 first lower roller unit
432 second lower roller unit
435 lower bearing shaft
44 first rear-sided cable connection device, preferably rear-sided upper cable connection device
440 first tensioning device
441 first entrance roller
4411 roller holder
4412 tensioning element, preferably tensioning screw or rivet
442 first connection sledge
4421, 4422 clamping jaws
4423 clamping screw
443 first pull spring
444 first pull sledge
445 first tensioning screw
446 first screw holder
4461 mounting screw
447 first measuring rod
4471 scale
448 first locking screw
449 first bearing profile
4490 first profile opening
4495 mounting strip
45 second rear-sided cable connection device, preferably rear-sided lower cable connection device
450 second tensioning device
451 second entrance roller
4511 roller holder
45111 mounting beam
4512 tensioning element, preferably tensioning screw or rivet
452 second connection sledge
4521, 4522 clamping jaws
4523 clamping screw
4453 second pull spring
454 second pull sledge
455 second tensioning screw
456 second screw holder
457 second measuring rod
4570 control window
4571 scale
459 bearing profile
4590 profile opening
4591 bearing openings
5 upper guide carriage
5F front carriage
51 upper carriage body
511 first carriage body part
5111 mounting sword
5112 holding plate
512 second carriage body part
5120 damper channel
5121 locking screw
53 stop member
55 coupling member
57 functional part
58 integrated carriage damper
591 support rollers
592 guide rollers
6 lower guide carriage
61 lower carriage body
68 integrated carriage damper
692 guide rollers
7 upper stop device
71 device body
710 retaining shell
711 mounting beam
712 locking screws
72 pull cord connection
74 front-sided second cable connection device
741 mounting channel
742 retaining block
75 upper locking lever
78 upper stop damper or stop buffer
781 buffer body
782 adjustment screw
79 upper spacer rollers
8 lower stop device
81 device body
810 retaining shell
811 mounting beam
812 locking screws
82 locking lever or lower pull cord connection
84 front-sided first cable connection device
840 setting device
841 mounting channel
842 setting sledge
843 bearing profile
845 setting screw
846 retaining body part
85 lower locking lever
86 adjustable plunger
861 adjustment screw
88 lower stop damper or stop buffer
881 buffer body
882 adjustment screw
89 lower spacer rollers
9 rear-sided stop, stop plate
90 rear-sided stop device
95 cyclically operating locking device
951 gripper
952 actuating rod
953 device housing
96 gripping element
99 damping device
991 damper piston
E Pull-in device
S driveway of the mounting profile 14
S1 first end position of the mounting profile 14
S2 second end position of the mounting profile 14

1. A displacement device for the installation in a door compartment of a functional entity with a mounting profile, which is held vertically aligned by a holding device displaceable between a first end position and a second end position of a driveway and which is connected or connectable by mounting hinges to a single-part or multi-part door; the holding device comprises
a first front-sided cable connection device, a first lower roller unit supported at a lower end of the mounting profile, a first upper roller unit supported at an upper end of the mounting profile, and a first rear-sided cable connection device, and a first holding cable connected by a first end piece to the first front-sided cable connection device, routed around the first lower roller unit and around the first upper roller unit, and connected by a second end piece to the first rear-sided cable connection d device; and
a second front-sided cable connection device, a second upper roller unit supported at the upper end of the mounting profile, a second lower roller unit unit supported at the lower end of the mounting profile, and a second rear-sided cable connection device, and a second holding cable connected by a first end piece to the second front-sided cable connection device, routed around the second upper roller unit and around the second lower roller unit and connected by a second end piece to the second rear-sided cable connection device,
wherein,
the second rear-sided cable connection device comprises a second tensioning device with a second pull spring, which on the one hand is connected directly or via a second connection sledge to the second holding cable and which on the other hand is connected to a second pull sledges, into which a second tensioning screw is screwed which is held in a fixed position and by means of which the second pull sledge can be displaced within a second bearing profile along its longitudinal axis in order to tension the second pull spring; and
the first rear-sided cable connection device or the first front-sided cable connection device comprises a first setting device with a first setting sledge, which on the one hand is connected to the fixed first holding cable and which on the other hand cooperates with a fixedly held setting screw, which is rotatably held in the first setting sledge.

2. The displacement device according to claim 1, wherein the first rear-sided cable connection device comprises a first tensioning device with a first pull spring, which on the one hand is connected directly or via a first connection sledge to the first holding cable and on the other hand is connected to a first pull sledge, into which a fixedly held first tensioning screw is screwed, by means of which the first pull sledge is displaceable within a first bearing profile along its longitudinal axis in order to tension the first pull spring.

3. The displacement device according to claim 2, wherein,
the first tensioning device comprises a first measuring rod aligned parallel to the longitudinal axis of the first bearing profile, that indicates the mutual displacement of the first pull sledge and of the first connection sledge, and that is connected to the first pull sledge or to the first connection sledge; or
the second tensioning device comprises a second measuring rod aligned parallel to the longitudinal axis of the second bearing profile, that indicates the mutual displacement of the second pull sledge and of the second connection sledge and that is connected to the second pull sledge or to the second connection sledge; or
the first tensioning device comprises a first measuring rod aligned parallel to the longitudinal axis of the first bearing profile, that indicates the mutual displacement of the first pull sledge and of the first connection sledge, and that is connected to the first pull sledge or to the first connection sledge ) and that the second tensioning device comprises a second measuring rod aligned parallel to the longitudinal axis of the second bearing profile, that indicates the mutual displacement of the second pull sledge and of the second connection sledge and that is connected to the second pull sledge or to the second connection sledge.

4. The displacement device according to claim 1, wherein,
the mounting profile is connected at an upper end piece to an upper guide carriage, which has an upper carriage body , and which is displaceably supported on an upper guide rail; or
the mounting profile is connected at a lower end piece to a lower guide carriage, which has a lower carriage body, and which is displaceably supported on a lower guide rail; or
the mounting profile is connected at an upper end piece to an upper guide carriage, which has an upper carriage body and which is displaceably supported on an upper guide rail, and that the mounting profile is connected at a lower end piece to a lower guide carriage, which has a lower carriage body and which is displaceably supported on a lower guide rail.

5. The displacement device according to claim 4, wherein,
the first front-sided cable connection device is arranged at the front-sided end of the lower guide rail,
the first rear-sided cable connection device is arranged at the rear-sided end of the upper guide rail,
the second front-sided cable connection device is arranged at the front-sided end of the upper guide rail,
the second rear-sided cable connection device is arranged at the rear-sided end of the lower guide rail,
the first lower roller unit and the second lower roller unit are supported in coaxial alignment with each other by a lower bearing shaft connected to the lower carriage body of the lower guide carriages, and
the first upper roller unit and the second upper roller unit are supported in coaxial alignment with each other by an upper bearing shaft connected to the upper carriage body of the upper guide carriages.

6. The displacement device according to claim 2, wherein,
the first front-sided cable connection device or the first rear-sided cable connection device comprises a clamping device by means of which the associated first or second end piece of the first holding cable is held; and/or
the second front-sided cable connection device or the second rear-sided cable connection device comprises a clamping device, by means of which the associated first or second end piece of the second holding cable is held.

7. The displacement device according to claim 2, wherein, that the first connection sledge is fixable within the first bearing profile or that the first connection sledge is fixable by means of a first locking screw within the first bearing profile.

8. The displacement device according to claim 1, wherein,
after installation of the displacement device the holding cable is firmly held by the fixed first connection sledge, and
after installation of the displacement device the tensioned second holding cable is elastically held by the second connection sledge and the second pull spring.

9. The displacement device according to claim 1, wherein,
the first bearing profile is aligned perpendicular to the direction of displacement of the mounting profile and holds a first entrance roller over which the first holding cable extends into the first bearing profile; and/or
the second bearing profile is aligned perpendicular to the displacement direction of the mounting profile and holds a second entrance roller over which the second holding cable extends into the second bearing profile.

10. The displacement device according to claim 1, wherein, at least one drive device is provided by means of which the mounting profile can be driven along the driveway or along a part of the driveway.

11. The displacement device according to claim 10, wherein, a first drive device is provided, which comprises a housing, in which a drive element and a pull cord connected thereto are provided, wherein the housing is directly or indirectly connected to the mounting profile and is displaceable together with the mounting profile, and that the pull cord which can be pulled out of the housing is guided directly or via a first deflection roller or via the first deflection roller and a second deflection roller to a pull cord connection, which is arranged stationary at the first or second end position of the driveway and is connected to the pull cord connection.

12. The displacement device according to claim 11, wherein, the first deflection roller is rotatably held by a deflection unit which is form-fittingly and/or force-fittingly held in a guide channel of the mounting profile displaceable and lockable.

13. A method for installing the displacement device according to claim 1, wherein,
the first holding cable is connected with a first end piece to the first front-sided cable connection device, routed around the first lower roller unit and around the first upper roller unit and connected with a second end piece to the first rear-sided cable connection device;
the second holding cable is connected with a first end piece to the second front-sided cable connection device, routed around the second upper roller unit and around the second lower roller unit and connected with a second end piece to the second rear-sided cable connection device;
the second holding cable is connected within the second rear-sided cable connection device to the second pull spring and tensioned by a predetermined amount; and
in that the first holding cable is tensioned by means of the first adjusting device which is provided in the first front-sided cable connection device or in the first rear-sided cable connection device, to vertically align the mounting profile.

14. The method for installing the displacement device according to claim 13, wherein,
the first holding cable is connected within the first rear-sided cable connection device to the first connection sledge, whereafter the first tensioning screw is turned and the first tensioning sledge and the first connection sledge, which are connected to each other by the first tension spring, are displaced by a predetermined amount with respect to each other;
the first connection sledge is fixed to the associated first bearing profile after impressing the predetermined tension, and
the first front-sided setting sledge of the first front-sided setting device of the first front-sided cable connection device, which is connected to the fixed first holding cable, is adjusted by means of the stationarily held setting screw to vertically align the mounting profile.

15. The method for installing the displacement device according to claim 13, wherein, the displacement device is provided in an assembly configuration which comprises
a mounting profile substitute which detachably holds the upper guide carriage and the lower guide carriage,
an upper guide rail substitute which detachably holds the upper stop device and the first rear-sided cable connection device, and which is connected to the upper guide carriage, and
a lower guide rail substitute which detachably holds the lower stop device and the second rear-sided cable connection device, and which is connected to the lower guide carriage, and
in which assembly configuration
the first holding cable is connected with a first end piece to the first front-sided cable connection device in the lower stop device, guided around the first lower roller unit and around the first upper roller unit and connected with a second end piece to the first rear-sided cable connection device; and
the second holding cable is connected by a first end piece to the second front-sided cable connection device on the upper stop device, is routed around the second upper roller unit and around the second lower roller unit and is connected by a second end piece to the second rear-sided cable connection device; and
that for the installation of the displacement device the mounting profile substitute is replaced by the mounting profile and the upper and lower guide rail substitutes are replaced by the upper and lower guide rails.

16. A functional entity, piece of furniture or room unit, with at least one door compartment, in which a mounting profile , which is connected by hinges to a one-piece or multi-part door, is held displaceably by means of a displacement device according to claim 1.
